(19) United States
(12) Patent Application Publication
(10) Pub. No.: US 2026/0116659 A1
(43) Pub. Date: Apr. 30, 2026

(54) LIFT ARM TENSIONER ASSEMBLY FOR REFUSE VEHICLE

(71) Applicant: Oshkosh Corporation, Oshkosh, WI (US)

(72) Inventors: Brent Radlinger, Oshkosh, WI (US); Ryan Ullius, Oshkosh, WI (US); Jeremy Kiekhaefer, Oshkosh, WI (US); Erik S. Ellifson, Oshkosh, WI (US)

(73) Assignee: Oshkosh Corporation, Oshkosh, WI (US)

(21) Appl. No.: 19/368,859

(22) Filed: Oct. 24, 2025

Related U.S. Application Data
(60) Provisional application No. 63/712,091, filed on Oct. 25, 2024.
(60) Provisional application No. 63/712,115, filed on Oct. 25, 2024.
(60) Provisional application No. 63/712,106, filed on Oct. 25, 2024.
(60) Provisional application No. 63/712,098, filed on Oct. 25, 2024.

(51) Int. Cl. B65F 3/08; B65F 3/02

(52) U.S. Cl. CPC B65F 3/08; B65F 2003/023; B65F 2003/025; B65F 2003/0269

(57) ABSTRACT

A lift arm tensioner assembly includes a support body, a sprocket mount, a lateral support element, and a plurality of connecting rods. The support body defines a first support surface, a plurality of tensioner openings, and a second support surface. The plurality of tensioner openings extend from the first support surface. The second support surface extends at an angle from the first support surface. The first support surface and the second support surface define an aperture extending through the support body. The sprocket mount is disposed within the aperture. The lateral support element is coupled to the support body and is disposed between the sprocket mount and the support body. The lateral support element is engageable with the sprocket mount. The plurality of connecting rods are disposed at least partially within respective ones of the plurality of tensioner openings and couple the sprocket mount to the support body.

### CROSS-REFERENCE TO RELATED APPLICATIONS

The present application claims the benefit of and priority to U.S. Provisional Patent Application No. 63/712,115 , filed Oct. 25, 2024, U.S. Provisional Patent Application No. 63/712,098, filed Oct. 25, 2024, U.S. Provisional Application No. 63/712,106, filed Oct. 25, 2024, and U.S. Provisional Application No. 63/712,091, filed Oct. 25, 2024. The entire contents of each of these applications is hereby incorporated by reference herein.

### BACKGROUND

The present application generally relates to the field of refuse vehicles and, more specifically, to lift apparatuses for refuse vehicles.

### SUMMARY

At least one exemplary embodiment of the present disclosure relates to a lift arm tensioner assembly. The lift arm tensioner assembly includes a support body, a sprocket mount, a lateral support element, and a plurality of connecting rods. The support body defines a first support surface, a plurality of tensioner openings, and a second support surface. The plurality of tensioner openings extend from the first support surface. The second support surface extends at an angle from the first support surface. The first support surface and the second support surface define an aperture extending through the support body. The sprocket mount is disposed within the aperture. The lateral support element is coupled to the support body and is disposed between the sprocket mount and the support body. The pad is engageable with the sprocket mount. The plurality of connecting rods are disposed at least partially within respective ones of the plurality of tensioner openings. The plurality of connecting rods couple the sprocket mount to the support body.

At least one exemplary embodiment of the present disclosure relates to a lift arm tensioner assembly including: a support body defining: a first support surface; a plurality of tensioner openings extending from the first support surface; and a second support surface extending at an angle from the first support surface, the first support surface and the second support surface defining an aperture extending through the support body; a sprocket mount disposed within the aperture; a lateral support element coupled to the support body and disposed between the sprocket mount and the support body, the lateral support element engageable with the sprocket mount; and a plurality of connecting rods disposed at least partially within respective ones of the plurality of tensioner openings, the plurality of connecting rods coupling the sprocket mount to the support body.

At least one exemplary embodiment of the present disclosure relates to a lift system for a refuse vehicle, the lift system including: a lift arm; a drive sprocket coupled to the lift arm at a first end of the lift arm; a follower sprocket coupled to the lift arm at a second end of the lift arm; a tensile member extending between the drive sprocket and the follower sprocket; and a chain tensioner assembly including: a support body defining an aperture; a sprocket mount disposed within the aperture; a lateral support element coupled to the support body and disposed between the sprocket mount and the support body, the lateral support element engageable with the sprocket mount; and a tensioner sprocket rotatably coupled to the sprocket mount and engaged with the tensile member.

At least one exemplar embodiment of the present disclosure relates to a support body for a chain tensioner assembly, the support body including: a first body portion defining: a first support surface; a plurality of tensioner openings extending from the first support surface; and a second support surface extending at an angle from the first support surface, a spacing between adjacent pairs of tensioner openings increasing moving away from the second support surface; and a second body portion extending from the first body portion, the first body portion and the second body portion together defining an aperture.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a refuse vehicle inclusive of a lift assembly, according to an exemplary embodiment;

FIG. 2 is another perspective view of the refuse vehicle of FIG. 1, according to an exemplary embodiment;

FIG. 3 is a front perspective view of the lift assembly of the refuse vehicle of FIG. 1, according to an exemplary embodiment;

FIG. 4 is a side perspective view of a chain drive assembly that may be used with the lift assembly of FIG. 3, according to an exemplary embodiment;

FIG. 5 is a side view of a chain tensioner assembly of the chain drive assembly of FIG. 4;

FIG. 6 is a perspective view of the chain tensioner assembly of FIG. 5, shown separated from other parts of the chain drive assembly, according to an exemplary embodiment;

FIG. 7 is a side cross-sectional view of the chain tensioner assembly of FIG. 5;

FIG. 8 is an enlarged side view of the chain drive assembly of FIG. 4; and

FIG. 9 is another side cross-sectional view of the chain drive assembly of FIG. 4.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the Figures, a chain tensioner assembly for a refuse container lift system of a refuse vehicle is shown, according to at least one exemplary embodiment. The chain tensioner assembly is configured to maintain a substantially vertical orientation of a lift chain of the lift system during all stages of system operation. The chain tensioner assembly is also structured to withstand lateral forces acting between the drive sprocket and the follower sprocket of the chain tensioner assembly that result from the weight of a carrier and the refuse container on the lift chain during system operation. In some embodiments, the chain tensioner assembly includes a support body defining an aperture extending through the support body along a rotational axis of the follower sprocket. The aperture is offset toward one side of the support body to thereby provide a lateral support surface that acts against lateral forces between the drive sprocket of the lift system and a sprocket mount of the chain tensioner assembly. In some embodiments, the chain tensioner assembly also includes a lateral support element (e.g., a pad, etc.) disposed between the support surface and the sprocket mount, which can further stabilize the sprocket mount and reduce wear of the support body and the sprocket mount.

In some embodiments, the chain tensioner assembly also includes multiple connecting rods (e.g., guide rails, etc.) that enable movement of the sprocket mount relative to the support body and along the support surface. In some embodiments, the distance between adjacent connecting rods decreases moving toward the support surface (e.g., the connecting rods are biased and/or offset toward the support surface) to bias the application of forces acting on the sprocket mount to a region that is closer to the support surface, which can further increase structural durability under lateral loads.

### Refuse Vehicle

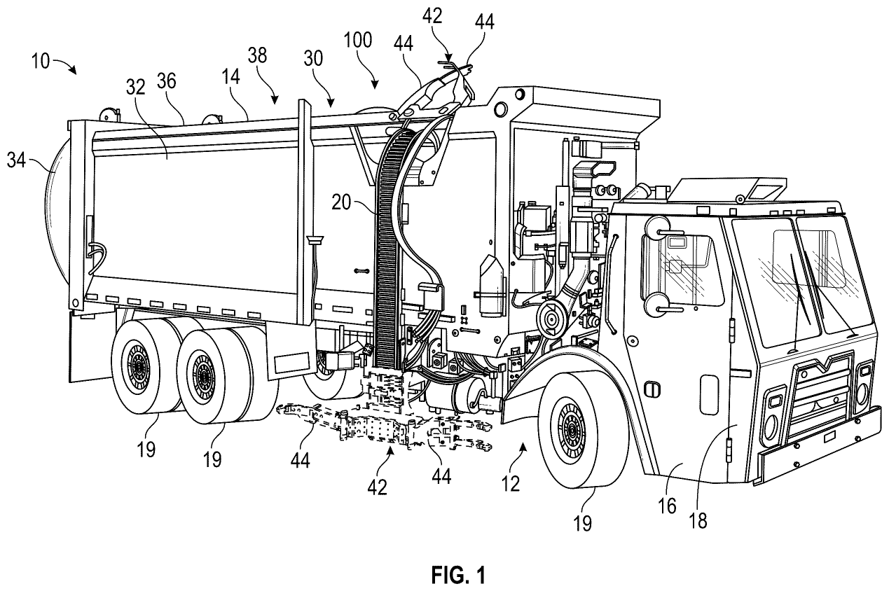

Referring to FIG. 1, a vehicle, shown as refuse vehicle 10 (e.g., a garbage truck, a waste collection truck, a sanitation truck, a refuse collection truck, a refuse collection vehicle, etc.), is configured as a side-loading refuse truck having a lift mechanism/system (e.g., a side-loading lift assembly, etc.), shown as lift assembly 100. The lift assembly 100 is coupled to a side of the refuse vehicle 10. In other embodiments, refuse vehicle 10 is configured as a front-loading refuse truck in which the lift assembly extends forward of the refuse vehicle, or a rear-loading refuse truck in which the lift assembly is disposed along a rear side of the refuse vehicle. In still other embodiments, the vehicle is another type of vehicle (e.g., a skid-loader, a telehandler, a plow truck, a boom lift, etc.).

As shown in FIG. 1, refuse vehicle 10 includes a chassis, shown as frame 12; a body assembly, shown as body 14, coupled to frame 12 (e.g., at a rear end thereof, etc.); and a cab, shown as cab 16, coupled to frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). As shown in FIG. 1, the refuse vehicle 10 includes a prime mover, shown as engine 18, coupled to the frame 12 at a position beneath the cab 16. The engine 18 is configured to provide power to a plurality of tractive elements, shown as wheels 19, and/or to other systems of the refuse vehicle 10 (e.g., a pneumatic system, a hydraulic system, an electric system, etc.). In some embodiments, the engine 18 is configured to utilize one or more of a variety of fuels (e.g., gasoline, diesel, bio-diesel, ethanol, natural gas, etc.). In some embodiments, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 together define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment 30). In other embodiments, the storage volume is positioned between the hopper volume and the cab 16 (e.g., a rear-loading refuse vehicle, etc.).

### Lift Assembly

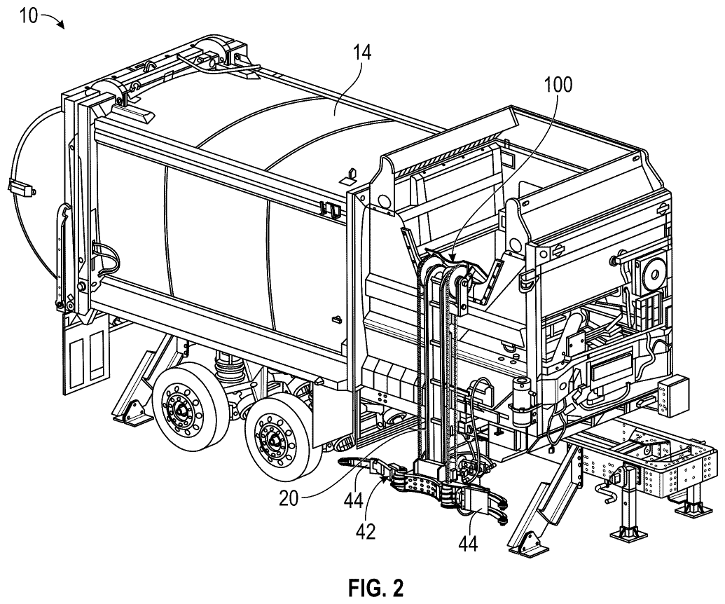

As shown in FIG. 1, the refuse vehicle 10 includes a lift mechanism/system (e.g., a front-loading lift assembly, etc.), shown as lift assembly 100. Referring to FIG. 2, in some embodiments, the lift assembly 100 includes a grabber assembly, shown as grabber assembly 42, movably coupled to a track 20, and configured to move along an entire length of the track 20. In the embodiment of FIG. 2, the track 20 extends along substantially an entire height of the body 14 and is configured to cause the grabber assembly 42 to tilt near an upper height of the body 14. In other embodiments, the track 20 extends along substantially an entire height of the body 14 on a rear side of the body 14. The refuse vehicle 10 can also include a reach system or assembly coupled with a body or frame of the refuse vehicle 10 and the lift assembly 100. The reach system can include telescoping members, a scissors stack, etc., or any other configuration that can extend or retract to provide additional reach of the grabber assembly 42 for refuse collection.

Referring still to FIG. 2, the grabber assembly 42 includes a pair of grabber arms, including a first grabber arm 44a and a second arm 44b (collectively, grabber arms 44). The grabber arms 44 are configured to rotate about an axis extending through a bushing. The grabber arms 44 are configured to releasably secure a refuse container to the grabber assembly 42, according to at least one embodiment. The grabber arms 44 rotate about the axis extending through the bushing to transition between an engaged state (e.g., a fully grasped configuration, a fully grasped state, a partially grasped configuration, a partially grasped state) and a disengaged state (e.g., a fully open state/configuration, a fully released state/configuration, a partially open state/configuration, a partially released state/configuration). In the engaged state, the grabber arms 44 are rotated towards each other such that the refuse container is grasped therebetween. In the disengaged state, the grabber arms 44 rotate outwards (as shown in FIG. 2) such that the refuse container is not grasped therebetween.

By transitioning between the engaged state and the disengaged state, the grabber assembly 42 releasably couples the refuse container with the grabber assembly 42. During a refuse collection event, the refuse vehicle 10 may pull up along-side the refuse container, such that the refuse container is positioned to be grasped by the grabber assembly 42 therebetween.

The grabber assembly 42 may then transition into an engaged state to grasp the refuse container. After the refuse container has been securely grasped, the grabber assembly 42 may be transported along the track 20 with the refuse container. When the grabber assembly 42 reaches the end of the track 20 (e.g., the upper end as shown in FIG. 2), the grabber assembly 42 may tilt and empty the contents of the refuse container in the refuse compartment 30. The tilting is facilitated by the path of the track 20. When the contents of the refuse container have been emptied into the refuse compartment 30, the grabber assembly 42 may descend along the track 20, and return the refuse container to the ground. Once the refuse container has been placed on the ground, the grabber assembly may transition into the disengaged state, releasing the refuse container.

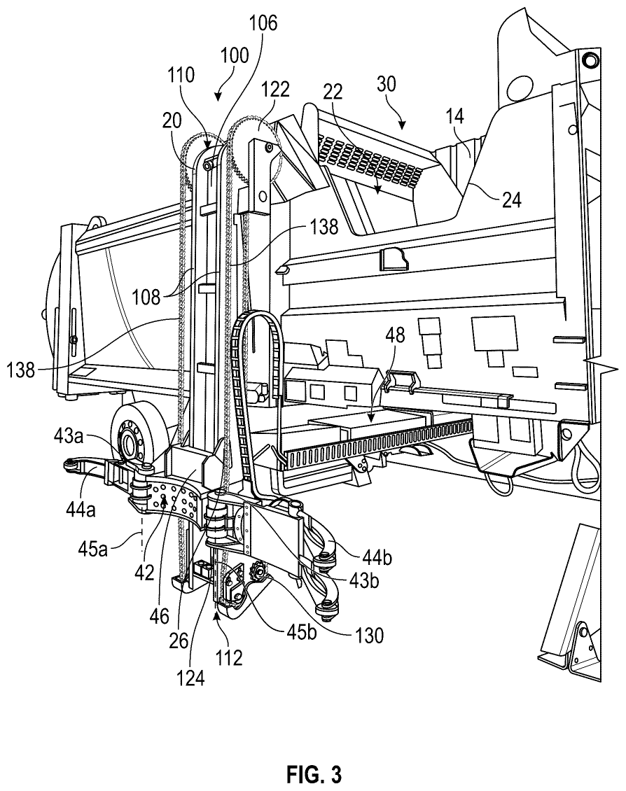

Referring to FIG. 3, the lift assembly 100 of FIG. 2 is shown in greater detail. The lift assembly 100 is configured to empty a refuse bin (e.g., a garbage can) releasably coupled to the grabber assembly 42 into the refuse compartment 30. The lift assembly 100 includes a track 20, and a coupling member, shown as carrier 26. The track 20 extends along substantially the entire height of body 14, according to the exemplary embodiment shown. The body 14 is shown to include a loading section (e.g., an opening, a hopper opening), shown as loading section 22. The loading section 22 is shown to include a recessed portion, shown as recessed portion 24.

The carrier 26 is coupled with track 20. The carrier 26 is coupled to the track 20 such that the carrier 26 may move along an entire path length of the track 20. The carrier 26 may be removably coupled to the grabber assembly 42, thereby removably coupling the grabber assembly 42 to the track 20, and allowing the grabber assembly 42 to travel along the entire path length of the track 20. The carrier 26 removably couples (e.g., by removable fasteners) to a carriage portion of the grabber assembly 42, shown as carriage 46. The grabber assembly 42 is shown to include grabber arms, shown as a first grabber arm 44a and a second grabber arm 44b, according to an exemplary embodiment. The first grabber arm 44a and the second grabber arm 44b are both configured to pivot about axis 45a and axis 45b, respectively. The axis 45a is defined as an axis longitudinally extending through substantially an entire length of a first adapter or bushing assembly, shown as a first adapter assembly 43a, and the axis 45b is defined as an axis longitudinally extending through substantially an entire length of a second adapter or bushing assembly, shown as a second adapter assembly 43b. The first adapter assembly 43a fixedly couples to a first end of carriage 46, and rotatably couples to the first grabber arm 44a.

The second adapter assembly 43b fixedly couples to a second end of the carriage 46, and rotatably couples to the second grabber arm 44b. The first adapter assembly 43a and the second adapter assembly 43b couple the first grabber arm 44a and the second grabber arm 44b to the carriage 46, and allow the first grabber arm 44a and the second grabber arm 44b to rotate about the axis 45a and the axis 45b, respectively.

In some embodiments, and as shown in FIG. 3, the lift assembly 100 also includes an extension assembly 48 that is configured to move the grabber assembly 42 laterally away from the body 14. In some embodiments, the lift assembly 100, the extension assembly 38, and the grabber assembly 42 are configured to perform a grasping, lifting, and dumping operation of a refuse container by (i) extending the extension assembly 48, (ii) grasping the refuse container with the grabber assembly 42 (e.g., between the grabber arms), (iii) retracting the extension assembly 48 to the refuse vehicle 10, (iv) lifting the grabber assembly 42 along the lift assembly 100 and dumping the contents of the refuse container, (v) returning the grabber assembly 42 to the ground, (vi) extending the extension assembly 48 and the grabber assembly 42 to its original location, and (vii) releasing the refuse container from the grabber assembly 42. In some embodiments, the lift assembly 100 also includes an unhinger apparatus disposed at an upper end of the lift assembly 100 to facilitate rotation of the refuse container and emptying the contents of the refuse container into the refuse compartment of the body 14.

Referring still to FIG. 3, the lift assembly 100 includes a lift arm 106 (e.g., a mast, etc.) along which a pair of track members 108 are positioned. The track members 108 may be positioned at opposite sides of the lift arm 106 and, in some embodiments, may form part of the lift arm 106. In some embodiments, the lift arm 106 has a U-shaped profile when viewed along a lift direction. In some embodiments, the lift arm 106 defines multiple inward facing surfaces and a space for a portion of the grabber assembly 42 to translate, travel, climb, or ascend along.

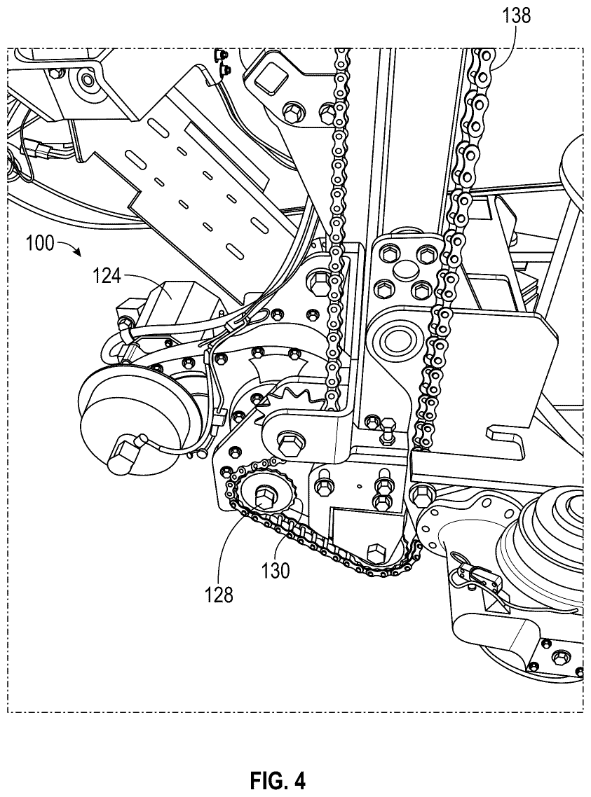

The lift assembly 100 includes a pair of drive sprockets 130 positioned at a bottom end 112 of the lift arm 106, and a pair of follower sprockets 122 or follower members (e.g., guides, pulleys, rollers, sprockets, etc.) positioned at an upper end 110 of the lift arm 106. Referring to FIG. 4, in some embodiments, the lift assembly 100 includes a drive motor 124 positioned at the bottom end 112 (e.g., a lower end, etc.) of the lift arm 106. The drive motor 124 is configured to operate to drive a pair of drive shafts 128 upon which the drive sprockets 130 are mounted. The lift assembly 100 also includes a pair of tensile members (e.g., chains, ropes, cables, bands, etc.), shown as chains 138 that extend between the drive sprockets 130 and the follower sprockets 122. The chains 138, drive sprockets 130, follower sprockets 122, and drive motor 124 together form at least part of a chain drive system (e.g., a chain drive assembly, etc.) that is configured to drive the grabber assembly 42 to ascend or descend the lift assembly 100.

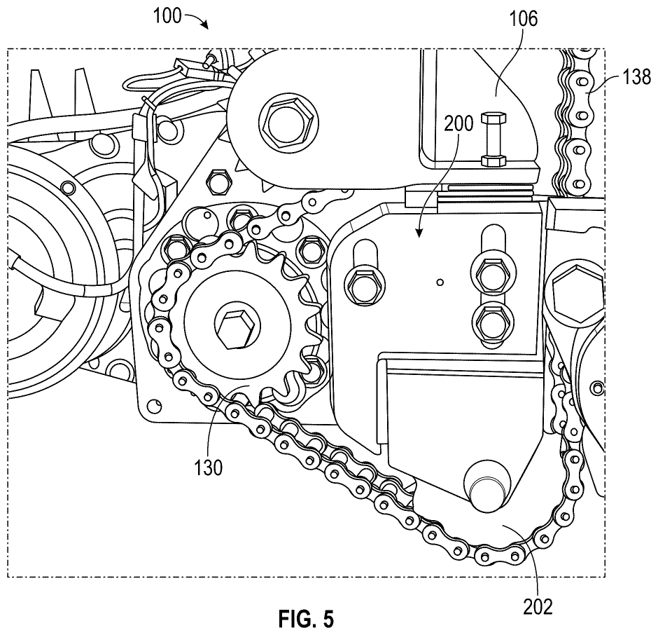

Referring to FIG. 5, the lift assembly 100 also includes a lift arm tensioner assembly, shown as chain tensioner assembly 200. The chain tensioner assembly 200 is configured to maintain adequate tension on a respective one of the lift chains throughout operation of the lift assembly 100. The chain tensioner assembly 200 also enables adjustment of a tension applied to the chain 138. In some embodiments, and as shown in FIG. 5, the chain tensioner assembly 200 is disposed at a lower end of the lift assembly 100. The chain tensioner assembly 200 is coupled to a lower end of the lift arm 106 and supports a lower end of the chain 138 during operation of the lift assembly 100. In other embodiments, the chain tensioner assembly 200 may be located at another position along the lift assembly 100.

Although embodiments of the chain tensioner assembly 200 are described herein as supporting the chain 138 of the lift assembly 100, it should be understood that the chain tensioner assembly 200 may also be used in various other applications, including various other chain drive systems, and that all such implementations are within the scope of the present disclosure.

In the embodiment of FIG. 5, the chain tensioner assembly 200 (e.g., the support body 204 and the sprocket mount 206) supports a tensioner sprocket 202 (e.g., a follow gear, a follower pulley, tensioner gear, etc.) in a position that is spaced laterally apart from, and vertically below, a respective one of the drive sprockets 130. The tensioner sprocket 202 is engaged with the chain 138. Referring to FIG. 3, the chain 138 extends in a loop, vertically (e.g., relative to a ground surface) between the follower sprocket and the tensioner sprocket 202, at least partially laterally and vertically between the tensioner sprocket 202 and the drive sprocket, and back vertically between the drive sprocket and the follower sprocket.

Referring to FIG. 5, the chain tensioner assembly 200 is structured to support the tensioner sprocket 202 under both lateral and vertical loads applied between the tensioner sprocket 202 and the respective one of the drive sprockets 130 through the chain 138. According to an exemplary embodiment, the chain tensioner assembly 200 (e.g., a support body 204, a sprocket mount 206, and lateral support element 208 together) supports the tensioner sprocket 202 in a substantially fixed lateral position so that the chain 138 is maintained in a substantially vertical orientation along the track.

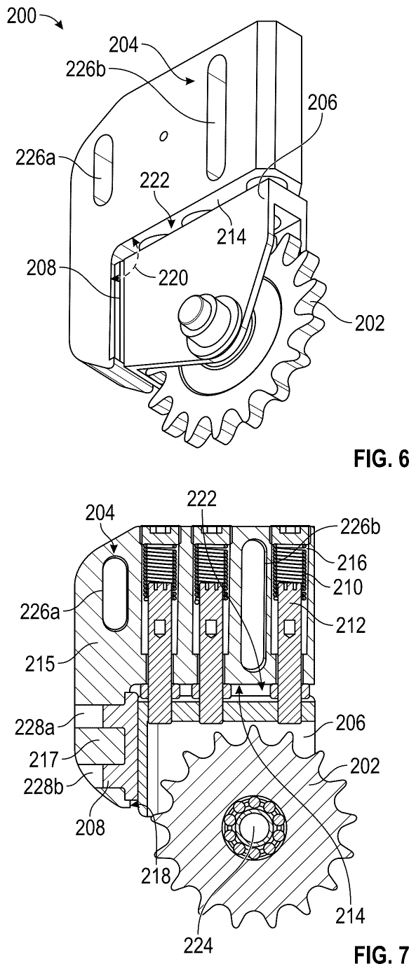

Referring to FIG. 6-7, the chain tensioner assembly 200 includes a support body 204; a sprocket mount 206; a lateral support element 208; a plurality of tensioner elements, shown as tensioner elements 210; and a plurality of connecting rods, shown as connecting rods 212. In other embodiments, the chain tensioner assembly 200 may include additional, fewer, and/or different components.

Referring to FIG. 7, the support body 204 is configured to guide movement of the sprocket mount 206 and to support the sprocket mount 206 under applied lateral and vertical forces (e.g., a lateral force acting to push the sprocket mount 206 toward the body 14 and a vertical force acting along a lift direction as shown in FIG. 3). In some embodiments, and as shown in FIG. 7, the support body 204 is a monolithic body made from a single piece of material (e.g., a metallic material such as a steel alloy, etc.). In other embodiments, the support body 204 is formed from multiple components that are fastened, welded, or otherwise coupled together.

The support body 204 defines a first support surface 214; a plurality of tensioner openings, shown as tensioner openings 216 extending from the first support surface 214; and a second support surface 218 extending at an angle 220 from the first support surface 214. In the embodiment of FIG. 7, the first support surface 214 and the second support surface 218 are substantially planar surfaces. The first support surface 214 is defined by an upper body portion 215 (which may also be referred to as a first body portion) of the support body 204 that extends across an entire width of the support body 204. The second support surface 218 is defined by a lower body portion 217 (which may also be referred to as a second body portion) of the support body 204 that extends from the upper body portion 215 at an end of the upper body portion 215. In some embodiments, and as shown, the upper body portion 215 and the lower body portion 217 together define an “L”shaped profile.

In some embodiments, and as shown, the second support surface 218 is substantially perpendicular to the first support surface 214. Such an arrangement can improve support of the sprocket mount 206 under applied lateral forces, as will be further described. In other embodiments, the angular orientation between the first support surface 214 and the second support surface 218 may be different.

The first support surface 214 and the second support surface 218 together define an aperture 222 (e.g., an opening, a receiving channel, etc.) extending through the support body 204 in a direction that is substantially parallel to a rotational axis 224 of the tensioner sprocket 202. The aperture 222 is sized to receive the sprocket mount 206 therein. In some embodiments, and as shown, the aperture 222 is a rectangular cutout having a substantially rectangular cross-section when viewed along the rotational axis 224.

The tensioner openings 216 extend through the upper body portion 215 of the support body 204, from the first support surface 214 through an upper end of the upper body portion 215. The tensioner openings 216 extend in a direction that is substantially perpendicular to the first support surface 214. In some embodiments, and as shown in FIG. 7, the upper body portion 215 defines a greater number of tensioner openings 216 proximate to an inner corner of the aperture 222 (e.g., proximate to the second support surface 218) as compared to an outer edge of the aperture 222 away from the second support surface 218. In some embodiments, a spacing between adjacent pairs of tensioner openings 216 increases moving away from the second support surface 218. Such an arrangement can enable greater application of force to the sprocket mount 206 proximate to a corner region of the support body 204, and to counteract any lateral forces applied to the tensioner sprocket 202.

The support body 204 (e.g., the upper body portion 215) also defines multiple elongated fastener openings extending therethrough, including a first fastener opening 226a and a second fastener opening 226b (collectively, fastener openings 226). The fastener openings 226 are configured to facilitate coupling of the support body 204 to the lift assembly. In some embodiments, and as shown in FIG. 7, the fastener openings 226 are slots that extend between upper and lower ends of the upper body portion 215. The arrangement of the fastener openings 226 may be different in various exemplary embodiments. In the embodiment of FIG. 7, at least one fastener opening (e.g., the second fastener opening 226b) is disposed in a space between adjacent ones of the tensioner openings 216 (e.g., between an outermost one of the tensioner openings 216 and the next adjacent tensioner opening).

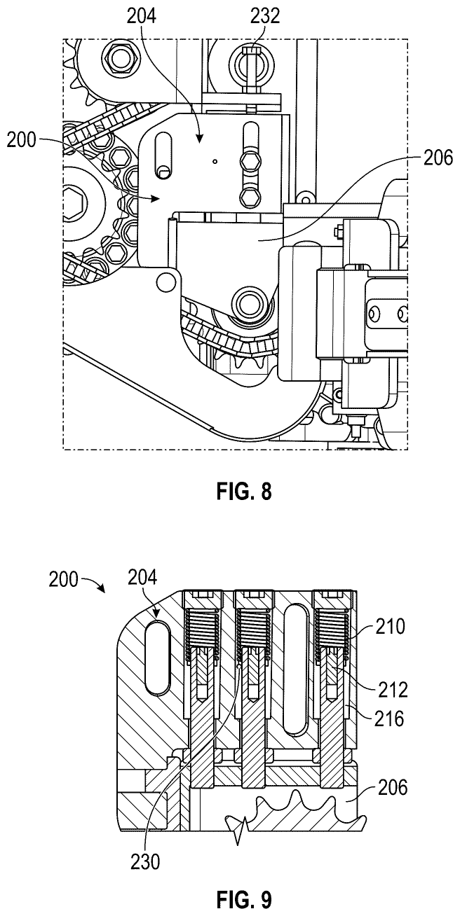

Referring to FIG. 8, the lift system also includes a locating bolt 232 (e.g., a jack bolt, etc.) coupled to the lift arm and engaged with the support body 204. In some embodiments, the locating bolt 232 is threadably coupled to the lift arm and is configured to adjust a vertical position of the support body 204 with respect to the lift arm.

Referring again to FIG. 7, the lower body portion 217 of the support body 204 defines multiple lateral openings 228 extending laterally therethrough. In some embodiments, the lateral openings 228 extend from the second support surface 218 in a lateral direction that is substantially perpendicular to the second support surface 218. In some embodiments, and as shown in FIG. 8, the lateral openings 228 are configured to facilitate mounting of the lateral support element 208 to the lower body portion 217.

In some embodiments, and as shown, the support body 204 also defines a lock aperture 230 (e.g., a lock opening, etc.) that extends through a sidewall of the support body 204 and into one of the tensioner openings 216. The lock aperture 230 may be disposed in a region adjacent to a sidewall of the tensioner opening. The lock aperture 230 is configured to receive a locking element (e.g., a pin, rod, key, etc.) to support at least one tensioner in a compressed position within the tensioner opening, as will be further described.

Referring still to FIG. 7, the sprocket mount 206 is coupled to the support body 204 and is disposed within the aperture 222. In some embodiments, and as shown, the sprocket mount 206 has a similar cross-sectional profile as the aperture 222. In such embodiments, the sprocket mount 206 nestably engages (nests with) the support body 204 at the aperture 222. The sprocket mount 206 is offset to one side of the support body 204 by the lower body portion 217. In some embodiments, and as shown in FIG. 6, the sprocket mount 206 has an overall thickness that is approximately the same as the depth of the aperture 222 along the rotational axis 224 of the tensioner sprocket 202. The sprocket mount 206 includes outer wall defining a “U” shaped channel that is sized to receive the tensioner sprocket 202 therein.

The tensioner sprocket 202 is rotationally coupled to the sprocket mount 206 by a bearing and/or bushing to enable relative rotation between the tensioner sprocket 202 and the sprocket mount 206.

The lateral support element 208 is engageable with a sidewall surface of the sprocket mount 206 and is configured to support the sprocket mount 206 under an applied lateral force from the chain. The lateral support element 208 is coupled to the support body 204 between the sprocket mount 206 and the support body 204 (e.g., the lower body portion 217). In some embodiments, and as shown in FIG. 7, the lateral support element 208 is coupled to the lower body portion 217 via mounts (e.g., cylindrical extensions, etc.) that extend into the lateral openings 228.

In some embodiments, the lateral support element 208 extends across and substantially covers the second support surface 218 to thereby form a protective barrier between the sprocket mount 206 and the second support surface 218. According to an exemplary embodiment, the lateral support element 208 is made from a different material than the support body 204 and having a lower coefficient of friction than the support body 204 to facilitate relative movement between the sprocket mount 206 and the lateral support element 208. For example, the lateral support element 208 may be made from a polymeric material (e.g., a plastic material) such as polyether ether ketone (PEEK), or another plastic or other material.

Referring still to FIG. 7, the connecting rods 212 (e.g., guide rails, guide pins, etc.) are configured to movably couple the sprocket mount 206 to the support body 204 and to guide movement of the sprocket mount 206 relative to the support body 204. The connecting rods 212 are disposed at least partially within respective ones of the tensioner openings 216. In some embodiments, and as shown in FIG. 7, the connecting rods 212 extend at least partially into the sprocket mount 206. The connecting rods 212 may be welded or otherwise affixed to the sprocket mount 206. In some embodiments, the chain tensioner assembly 200 also includes stops coupled to the connecting rods 212, and disposed between the sprocket mount 206 and the first support surface 214, to substantially limit vertical movement of the sprocket mount 206 relative to the support body 204 (e.g., to prevent the sprocket mount 206 and/or connecting rods 212 from bottoming out against the support body 204.

In the embodiment of FIG. 7, the chain tensioner assembly 200 includes three connecting rods 212. In other embodiments, the chain tensioner assembly 200 may include a different number of connecting rods 212. A spacing between adjacent connecting rods increases moving away from the second support surface 218. Two of the connecting rods 212 are disposed in a half region of the aperture 222 along the first support surface 214 that is adjacent to the second support surface 218 (e.g., between a center or middle of first support surface 214 and a lateral end of the first support surface that is adjacent to the second support surface 218). In such an arrangement, a net force applied by the connecting rods 212 to the sprocket mount 206 is biased toward the second support surface 218 instead of being uniform across an upper wall of the sprocket mount 206.

The tensioner elements 210 are configured to support the connecting rods 212 in compression against the sprocket mount 206. In the embodiment of FIG. 7, each of the tensioner elements 210 is a helical coil spring that is connected between respective ones of the connecting rods 212 and the support body 204. Each of the tensioner elements 210 is disposed within a respective one of the tensioner openings 216 and is connected to a respective ones of the connecting rods 212 by a bolt or another mechanical fastener at an end of the connecting rods 212 (e.g., a bolt extending into an axial end of the connecting rod 212, etc.).

Referring to FIG. 8-9, a method of adjusting the chain tensioner assembly 200 of FIG. 4-7 is shown, according to an exemplary embodiment. The method includes retracting (e.g., manually) the sprocket mount 206 toward the support body 204 by pressing the sprocket mount 206 toward the support body 204. For example, the method may include compressing the tensioner elements 210 within the support body 204.

In some embodiments, the method also includes locking the sprocket mount 206 in a retracted position relative to and/or against the support body 204. For example, the method may include compressing the tensioner elements 210 so that a head of the tensioner fasteners (e.g., bolts) within the tensioner openings 216 moves axially across a lock aperture 230 (e.g., a lock opening, etc.) that extends through a sidewall of the support body 204. In such embodiments, the method may include inserting a locking pin into the lock aperture 230 to substantially prevent the connecting rods 212 from moving out of the support body 204 to an extended position.

The method may include loosening fasteners disposed within the fastener openings 226 to enable vertical movement of the support body 204 relative to the lift arm. The method may further include adjusting a locating bolt 232 (e.g., a jack bolt, etc.) to set an initial position between the support body 204 and the lift arm before retightening the fasteners securing the support body 204 to the lift arm. The method may further include removing the locking pin from the lock aperture 230 to apply tension to between the tensioner sprocket 202 and the chain.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift arm tensioner assembly as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A lift arm tensioner assembly comprising:
a support body defining:
a first support surface;
a plurality of tensioner openings extending from the first support surface; and
a second support surface extending at an angle from the first support surface, the first support surface and the second support surface defining an aperture extending through the support body;
a sprocket mount disposed within the aperture;
a lateral support element coupled to the support body and disposed between the sprocket mount and the support body, the lateral support element engageable with the sprocket mount; and
a plurality of connecting rods disposed at least partially within respective ones of the plurality of tensioner openings, the plurality of connecting rods coupling the sprocket mount to the support body.

2. The lift arm tensioner assembly of claim 1, wherein a force applied by the plurality of connecting rods to the sprocket mount when the sprocket mount is pushed toward the support body is biased toward the second support surface.

3. The lift arm tensioner assembly of claim 1, wherein a spacing between adjacent connecting rods increases moving away from the second support surface.

4. The lift arm tensioner assembly of claim 1, wherein the support body is made from a metallic material, and the lateral support element is made from a plastic material.

5. The lift arm tensioner assembly of claim 1, wherein the second support surface extends substantially perpendicular to the first support surface.

6. The lift arm tensioner assembly of claim 1, further comprising a sprocket rotatably coupled to the sprocket mount, wherein the aperture extends through the support body in a direction substantially parallel to a rotational axis of the sprocket.

7. The lift arm tensioner assembly of claim 1, wherein the lateral support element is coupled to the support body at the second support surface and extends across the second support surface.

8. The lift arm tensioner assembly of claim 1, wherein the support body further defines a plurality of elongated fastener openings extending therethrough, at least one of the elongated fastener openings disposed between adjacent ones of the connecting rods.

9. The lift arm tensioner assembly of claim 1, further comprising a plurality of tensioner elements supporting the connecting rods in compression against the sprocket mount.

10. A lift system for a refuse vehicle, the lift system comprising:
a lift arm;
a drive sprocket coupled to the lift arm at a first end of the lift arm;
a follower sprocket coupled to the lift arm at a second end of the lift arm;
a tensile member extending between the drive sprocket and the follower sprocket; and
a chain tensioner assembly comprising:
a support body defining an aperture;
a sprocket mount disposed within the aperture;
a lateral support element coupled to the support body and disposed between the sprocket mount and the support body, the lateral support element engageable with the sprocket mount; and
a tensioner sprocket rotatably coupled to the sprocket mount and engaged with the tensile member.

11. The lift system of claim 10, wherein the support body, the sprocket mount, and the lateral support element together support the tensioner sprocket in a substantially fixed position along a lateral direction while permitting movement of the tensioner sprocket in a vertical direction that is substantially perpendicular to the vertical direction.

12. The lift system of claim 10, further comprising a carrier coupled with the lift arm and the tensile member such that movement of the tensile member causes the carrier to move between opposing ends of the lift arm.

13. The lift system of claim 10, wherein the support body and the sprocket mount support the tensioner sprocket in a position that is spaced laterally apart from the drive sprocket and vertically below the drive sprocket.

14. The lift system of claim 10, the chain tensioner assembly further comprising a plurality of connecting rods coupling the sprocket mount to the support body, wherein a spacing between adjacent connecting rods increases moving from a first side of the sprocket mount to a second side of the sprocket mount opposite the first side.

15. The lift system of claim 10, wherein a coefficient of friction of the lateral support element is less than a coefficient of friction of the support body.

16. The lift system of claim 10, wherein the support body further defines a plurality of elongated fastener openings extending therethrough, the chain tensioner assembly including a plurality of fasteners coupling the support body to the lift arm through the elongated fastener openings, the lift system further comprising a locating bolt engaged with the support body and configured to adjust a position of the support body with respect to the lift arm.

17. A support body for a chain tensioner assembly, the support body comprising:
a first body portion defining:
a first support surface;
a plurality of tensioner openings extending from the first support surface; and
a second support surface extending at an angle from the first support surface, a spacing between adjacent pairs of tensioner openings increasing moving away from the second support surface; and
a second body portion extending from the first body portion, the first body portion and the second body portion together defining an aperture.

18. The support body of claim 17, wherein the second body portion defines at least one lateral opening extending from the second support surface in a lateral direction that is substantially perpendicular to the second support surface.

19. The support body of claim 17, wherein the first body portion further defines a lock aperture extending through a sidewall of the first body portion and into one of the tensioner openings.

20. The support body of claim 17, wherein the first body portion further defines a plurality of elongated fastener openings extending therethrough, at least one of the elongated fastener openings disposed between adjacent ones of the tensioner openings.
